(19) United States
(12) Patent Application Publication
(10) Pub. No.: US 2010/0045821 A1
(43) Pub. Date: Feb. 25, 2010

(54) DIGITAL CAMERA INCLUDING A TRIGGERING DEVICE AND METHOD FOR TRIGGERING STORAGE OF IMAGES IN A DIGITAL CAMERA

(75) Inventor: Iwo Martin Mergler, Miranda (AU)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/195,511

(22) Filed: Aug. 21, 2008

(51) Int. Cl. H04N 5/76

(52) U.S. Cl. 348/231.2

(57) ABSTRACT

A digital camera includes an image sensor; a buffer memory adapted to receive images from the image sensor and to store the images therein; an image processor adapted to receive selected images and to process the selected images, including applying a video compression algorithm to the selected images; an image storage device adapted to store the processed, selected images; and an image selector adapted to select the selected images among the stored images in the buffer memory based on at least one image selection criterion, and to cause unselected stored images to be discarded from the buffer memory.

### TECHNICAL FIELD

This invention pertains to a digital camera, and in particular, to a device and method for triggering a digital camera to save images.

### BACKGROUND AND SUMMARY

Digital cameras have become increasingly popular in the past few years and are replacing traditional film-based cameras for many users.

However, until now, digital cameras typically have exhibited some disadvantages compared to traditional film-based cameras. One shortcoming of digital cameras has been the difficulty they present for a user who is trying to capture a transient image. In particular, there is normally a delay between when a user depresses a shutter control and when an image is captured by the camera. This can make it very difficulty for a user to depress the shutter at the precise instant that is necessary to have the camera capture a desired ephemeral image.

Accordingly, it would be desirable to provide a digital camera which facilitates the capture of desired transient images.

In one aspect of the invention, a digital camera comprises: an image sensor; a buffer memory adapted to receive images from the digital image sensor and to store the images therein; an image processor adapted to receive selected images and to process the selected images, including applying a video compression algorithm to the selected images; an image storage device adapted to store the processed, selected images; and an image selector adapted to select the selected images among the stored images in the buffer memory based on at least one image selection criterion, and to cause unselected stored images to be discarded from the buffer memory.

In another aspect of the invention, a method of storing images comprises: sensing images; processing selected images, including applying a video compression algorithm to the selected images; storing the processed, selected images in a storage device; selecting the selected images among the sensed images based on at least one image selection criterion; and causing unselected images to be discarded.

In yet another aspect of the invention, a digital camera comprises: an image sensor adapted to sense images; an image processor adapted to receive selected images and to process the selected images, including applying a video compression algorithm to the selected images; an image storage device adapted to store the processed, selected images; and an image selector adapted to select the selected images among the sensed images based on at least one image selection criterion, and to cause unselected images to be discarded.

### BRIEF DESCRIPTION OF THE DRAWINGS

FIG. 1 is a functional block diagram of a certain portions of a digital camera.

FIG. 2 is a functional block diagram of one embodiment of a digital camera that includes an image selector.

FIG. 3 is a functional block diagram of another embodiment of an image selector.

FIG. 4 is a functional block diagram of one embodiment of an image selector.

FIG. 5 is a functional block diagram of another embodiment of a digital camera that includes an image selector.

### DETAILED DESCRIPTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided as teaching examples of the invention.

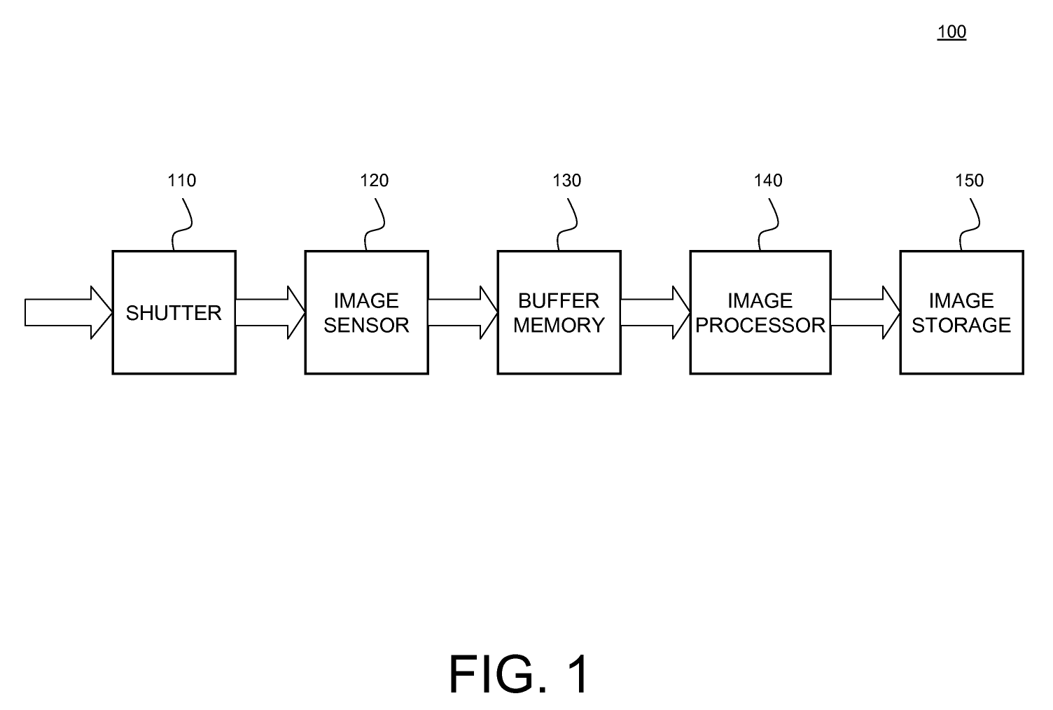

FIG. 1 is a high level functional block diagram of certain portions of a digital camera 100.

Digital camera 100 includes shutter 110, an image sensor 120, a buffer memory 130, an image processor 140, and an image storage device (e.g., memory) 150.

Shutter 110 controls a time period during which digital camera 100 senses an image. Normally, the shutter is controlled by a user depressing a shutter button on the housing of digital camera 100.

Image sensor 120 senses an image from light provided to the camera when shutter 100 is opened. Beneficially, image sensor 120 includes a plurality of pixels which respond to light to produce image data representing the sensed image. Image sensor 110 may be a charge-coupled device (CCD) sensor, a complementary metal oxide semiconductor (CMOS) sensor, or other convenient sensor.

When image sensor 120 captures an image, it outputs the corresponding image data to buffer memory 130. In a typical arrangement, buffer memory 130 comprises a relatively high speed semiconductor memory device. In one embodiment, buffer memory 130 comprises synchronous dynamic random access memory (SDRAM). Typically, buffer memory 130 has sufficient capacity to store in a range of 2-10 uncompressed images.

Image data stored buffer memory 130 is subsequently processed by image processor 140 in the background while additional images may be captured by image sensor 120 and stored in buffer memory 130. In general, image processor 140 compresses the images stored in buffer memory 130, for example, by applying joint picture experts group (JPEG) compression. In the compression process, image processor 140 may compress the size of the image data for each image by a factor of 10, 20 or more, before the compressed image is stored on image storage device 150.

Beneficially, image storage device 150 comprises nonvolatile memory. In one embodiment, image storage device 150 comprises flash memory. Normally, image storage device 150 is a removable memory device that typically has a capacity or anywhere from tens of megabytes up to several gigabyte. Image storage device 150 is generally compliant with one of various standards for removable memory devices such as smart disk, secure digital, memory stick, XD, etc.

The most time consuming process in digital camera 100 is the compression process performed by image processor 140. Ultimately, it is this compression process which limits the speed at which digital camera can continue to capture new images.

As explained above, one challenge faced by digital cameras is the difficulty it presents for a user who is trying to capture a transient image.

To address this challenge, many digital cameras have a “fast shooting mode” that allows a user to take a series of pictures in quick succession. In the fast shooting mode, images from image sensor 120 are stored in buffer memory 130 very rapidly, while the image compression process of image processor 140 lags far behind. Images can continue to be captured at the rapid rate of image sensor 120 and buffer memory 130 only until all of the available space in buffer memory 130 is exhausted. At that point, the speed of the fast shooting mode drops to the much slower image compression rate which governs how quickly capacity in buffer memory 130 is freed up to store additional images. Buffer memory 130 normally has only sufficient space for 2-10 uncompressed images. So it can be seen that very quickly, the fast shooting mode is reduced to the relatively slow image compression speed of image processor 140. Typically, this happens after only a few seconds in the fast shooting mode.

Accordingly, there is a limitation to how effective a fast shooting mode can be in assisting a human photographer in capturing a fleeting event at the precise instant when it occurs.

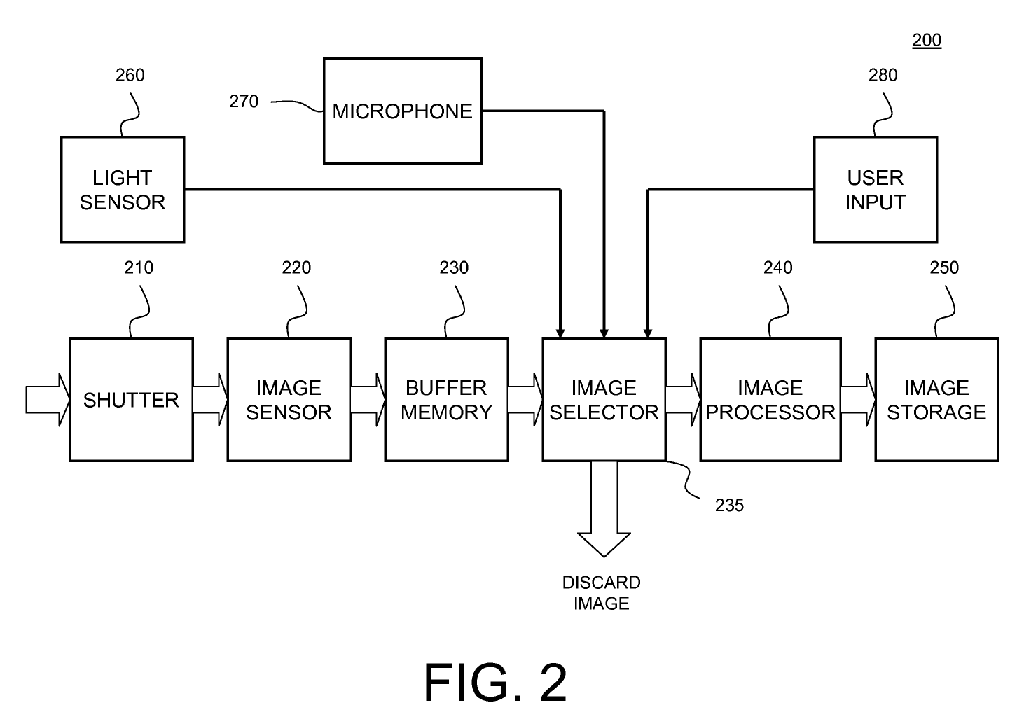

FIG. 2 is a functional block diagram of a digital camera 200 that includes an image selector. As will be appreciated by those skilled in the art, the various “parts” shown in FIG. 2 may be physically implemented using a software-controlled microprocessor, hard-wired logic circuits, or a combination thereof. Also, while the parts are functionally segregated in FIG. 2 for explanation purposes, they may be combined in various ways in any physical implementation.

Digital camera 200 includes shutter 210, an image sensor 220, a buffer memory 230, an image selector 235, an image processor 240, an image storage device (e.g., memory) 250, a light sensor 260, a microphone 270, and a user input 280.

Typically, all of the components of digital camera 200 shown in FIG. 2 are provided in a common housing. It will be understood that digital camera 200 will include a number of other components not shown in FIG. 2. Such components may include, a lens, a viewfinder, a display, a power supply (including, e.g., batteries), various user controls, a processor, etc. Also, digital camera 200 may be a part of a multipurpose device, such as a mobile telephone, a portable computing device, etc. In that case, one or more of the functional blocks shown in FIG. 2 may be realized with components that perform other functions from the multipurpose device.

Many of the functional blocks in digital camera 200 of FIG. 2 are similar to corresponding blocks in digital camera 100 of FIG. 1 which have been discussed above, and so a detailed description of them will not be repeated.

Beneficially, digital camera 200 includes image selector 235. Image selector allows digital camera 200 to discard images which are determined not to be likely to be of particular interest without compressing them or storing them in image storage device 250. For example, when digital camera 200 is operated in a fast shooting mode, image selector 240 can discard redundant images before compression, and thereby allow digital camera 200 to capture only those images likely to be desired by a user, and to do so for an extended period of time. This enhances the likelihood that digital camera 200 will successfully capture ephemeral images that are more likely to be of interest to the user.

In particular, image selector 235 employs one or more image selection criteria for determining which images in buffer memory 230 are to be processed by image processor 240, and which images are to be discarded without processing (e.g., compression) by image processor 240.

The decision which frames to store and which to discard can be made based on external sensor data, or properties of the images themselves, or combinations of both. Beneficially, the selection criteria are chosen to correlate events with the open shutter time during which an image was taken.

In one embodiment, light sensor 260, typically used for iris or flash control, is sampled to determine if there was a change in overall lighting level during the shutter period. The sampling period for light sensor 260 may optionally include time before and/or after the shutter period. This approach effectuates a crude motion sensor which tags the picture in question with a value related to the lighting level. Image selector 235 may compare the change in light intensity against a fixed threshold, or against a change in light intensity for other images, as a selection criterion for determining which images are processed by image processor 240 and stored in image storage 250, and which images are discarded.

Alternatively, an overall intensity of the light sensed by light sensor 250 may be used as a selection criterion to discard images that are too dark or too bright to be visible and therefore, are unlikely to be of interest. In that case, image selector 235 may compare the light intensity to one or more thresholds, and select images for processing and storage, or to be discarded, depending upon the relationship between the light intensity when the image was captured, and the threshold(s).

In another embodiment, a sound level detected by microphone 270 may be processed in a similar manner to the overall light level. For example, image selector 235 uses sudden changes in sound volume during the exposure time as a selection criterion to indicate moments of interest and corresponding images to be processed and stored.

In a further embodiment, a user may stop a continuous shooting mode (without storage) by operating a user control (e.g., a shutter button) to capture a number of images before and after the user depresses the shutter button. In other words, in such an embodiment, user input 280 is a user-operable shutter control that allows a user to indicate in a continuous shooting mode a time instant at which the user desires to capture an image. In that case, the image selection criterion can be the difference between the time instant indicated by the user and the time instant when a particular image is sensed by the digital image sensor. Image detector 235 can compare this time difference to a predetermined threshold to determine whether or not the image was sensed close enough in time to the user-indicated instant. Thus, the “right” instant for capturing an image is indicated by the user, with a margin for error.

In still another embodiment, images stored in buffer memory 230 are compared against each other, for instance, to determine motion between the frames. To save time, this process could be limited to partial pictures (e.g. a center point of an image) or a grid of sampling points. In particular, one or more characteristics of a first image are compared against one or more characteristics of a second image. In that case, when the amount of change between the characteristic(s) of the images is determined to be greater than some threshold, then one or both of the images may be scheduled for compression and storage. This embodiment effectuates a more sophisticated motion sensing, where the camera can trap sudden unexpected motion—common, for instance in wildlife photography.

In yet another embodiment, the buffered images in buffer memory 230 are analyzed individually. Such analysis may include space and/or frequency domain analysis to detect one or more characteristics, such as brightness, hue, sharpness, etc. Image selector 235 can compare the detected characteristic(s) of an image against a threshold as a selection criterion for determining whether the image is to be processed by image processor 240 and stored in image storage 250, or to be discarded.

Due to its nature, image processor 240 is very well suited to frequency domain analysis, as this is a significant part of the JPEG compression algorithm. In that case, beneficially, image selector 235 may be combined with image processor 240. Again, in some cases the analysis may be applied only to parts of an image.

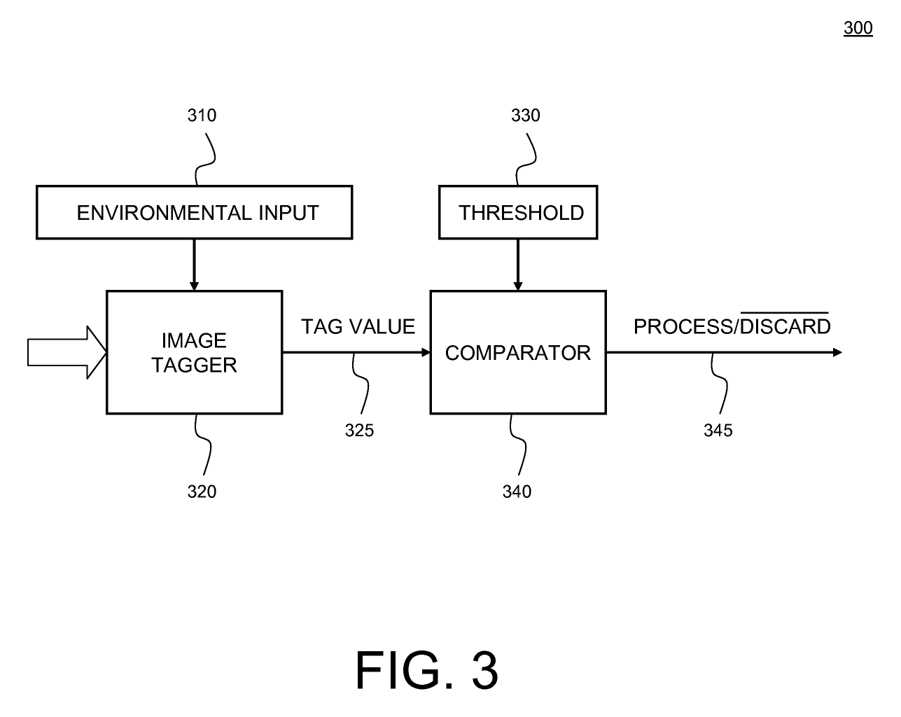

FIG. 3 is a functional block diagram of one embodiment of an image selector 300.

Image selector 300 includes an environmental sensor(s) 310, an image tagger 320, a threshold 330, and a comparator 340. Environmental sensor(s) 310 may comprise light sensor 260, microphone 270, etc., and/or user input 280. Environmental data provided by environmental sensor(s) may include a light intensity, a change in light intensity, a sound volume, a change in sound volume, a time at which an image in captured with respect to a time selected by a user, etc.

Image tagger 320 tags each image stored in buffer memory 230 with one or more tag values corresponding to the environmental data for that image.

Comparator 340 compares the tag value(s) 325 against one or more threshold(s) 330 and outputs one or more signals 345 which indicate whether to process and store the corresponding image, or to discard it.

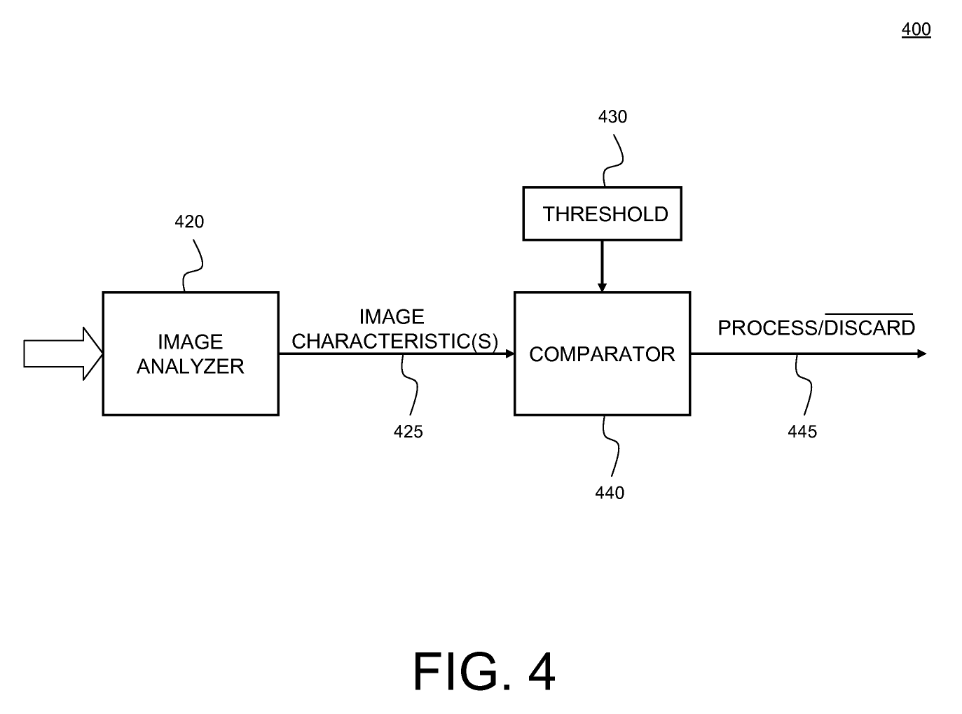

FIG. 4 is a functional block diagram of another embodiment of an image selector 400.

Image selector 400 includes an image analyzer 420, a threshold 430, and a comparator 440. Image analyzer may perform space and/or frequency domain analysis of an image to detect one or more characteristics of the image, such as brightness, hue, sharpness, etc., and/or a change in any of these characteristics between a first image and a second image. Image analyzer 420 outputs one or more characteristics of an image and/or differences between one or more characteristics of a first image and a second image.

Comparator 440 compares the image characteristic(s), and/or differences in characteristics between a first image and a second image, against one or more threshold(s) 430 and determines whether to process and store the corresponding image, or to discard it.

In some embodiments, image selector 240 can be conceptualized as a triggering device that triggers images for processing and storage by image camera 200.

Many variations of digital camera 200 are possible within the scope of the principles discussed above. For example, in some embodiments, one or all of light sensor 260, microphone 270, and/or user input 280 may be omitted, and/or may not be connected to image selector 235.

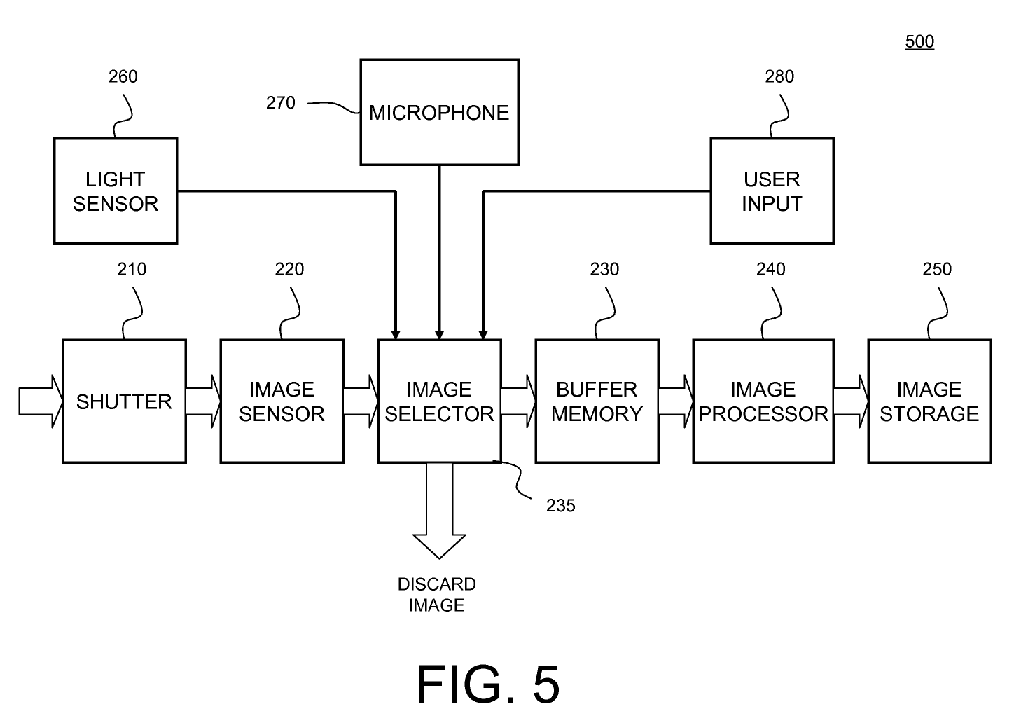

When external events are used for the selection criteria, in some embodiments it is not necessary to actually store the image in buffer memory before making the decision whether to process it or drop it. FIG. 5 is a functional block diagram of another embodiment of a digital camera 500 that includes an image selector 240, where the image selector 240 decides whether to process or discard a sensed image prior to storage in buffer memory. As will be appreciated by those skilled in the art, the various “parts” shown in FIG. 5 may be physically implemented using a software-controlled microprocessor, hard-wired logic circuits, or a combination thereof Also, while the parts are functionally segregated in FIG. 5 for explanation purposes, they may be combined in various ways in any physical implementation.

The functional blocks in FIG. 5 are similar to those described above with respect to FIG. 2, with a principle difference being the order of arrangement of buffer memory 230 and image selector 240. In digital camera 500, image selector operates with image selection criteria derived from external sensor data, rather than on properties of the images themselves. Accordingly, image selector 240 in digital camera 500 is able to make the decision whether to process or discard an image before it is even stored in buffer memory 230.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

What is claimed is:

1. A digital camera, comprising:
an image sensor;
a buffer memory adapted to receive images from the image sensor and to store the images therein;
an image processor adapted to receive selected images and to process the selected images, including applying a video compression algorithm to the selected images;
an image storage device adapted to store the processed, selected images; and
an image selector adapted to select the selected images among the stored images in the buffer memory based on at least one image selection criterion, and to cause unselected stored images to be discarded from the buffer memory.

2. The digital camera of claim 1, further comprising a light sensor, and wherein the at least one image selection criterion includes a change in a light intensity detected by the light sensor during a light detection time period that includes a time period during which a stored image is sensed by the digital image sensor.

3. The digital camera of claim 1, further comprising a light sensor, and wherein the at least one image selection criterion includes an intensity of light detected by the light sensor during a light detection time period that includes a time period during which a stored image is sensed by the digital image sensor.

4. The digital camera of claim 1, further comprising a microphone, and wherein the at least one image selection criterion includes a change in a sound level detected by the microphone during a sound detection time period that includes a time period during which a stored image is sensed by the digital image sensor.

5. The digital camera of claim 1, further comprising a user-operable shutter control for allowing a user to indicate in a continuous shooting mode a time instant at which the user desires to capture an image, and wherein the at least one image selection criterion includes a difference between the time instant indicated by the user and a time instant when an image is sensed by the digital image sensor.

6. The digital camera of claim 1, wherein the at least one image selection criterion includes a difference between at least one characteristic of a first image and the at least one characteristic of a second image.

7. The digital camera of claim 1, wherein the at least one image selection criterion includes a characteristic of image data comprising an image.

8. A method of storing images, comprising:
sensing images;
processing selected images, including applying a video compression algorithm to the selected images;
storing the processed, selected images in a storage device; and
selecting the selected images among the sensed images based on at least one image selection criterion; and causing unselected images to be discarded.

9. The method of claim 8, further comprising storing the sensed images in a buffer memory, and wherein selecting the selected images comprises selecting the selected images from the buffer memory and wherein the unselected images are discarded from the buffer memory.

10. The method of claim 8, further comprising storing the selected images into a buffer memory prior to processing the selected images, and wherein the unselected images are not stored in the buffer memory.

11. The method of claim 8, further comprising detecting a change in a light intensity during a light detection time period that includes a time period during which an image is sensed, and wherein the at least one image selection criterion includes the change in a light intensity.

12. The method of claim 8, further comprising detecting an intensity of light during a light detection time period that includes a time period during which an image is sensed, and wherein the at least one image selection criterion includes the detected intensity of the light.

13. The method of claim 8, further comprising detecting a change in a sound level during a sound detection time period that includes a time period during which an image is sensed, and wherein the at least one image selection criterion includes the change in the sound level.

14. The method of claim 8, further comprising detecting a time difference between a user-selected time instant for capturing an image while operating the camera in a continuous shooting mode, and a time instant when an image is sensed by the digital image sensor, and wherein the at least one image selection criterion includes the time difference.

15. The method of claim 8, further comprising determining a difference between at least one characteristic of a first image and the at least one characteristic of a second image, and wherein the at least one image selection criterion includes the difference.

16. The method of claim 8, further comprising determining at least one characteristic of image data comprising an image, and wherein the at least one image selection criterion includes the characteristic the image data.

17. A digital camera, comprising:
an image sensor adapted to sense images;
an image processor adapted to receive selected images and to process the selected images, including applying a video compression algorithm to the selected images;
an image storage device adapted to store the processed, selected images; and
an image selector adapted to select the selected images among the sensed images based on at least one image selection criterion, and to cause unselected images to be discarded.

18. The digital camera of claim 17, further comprising a buffer memory, and wherein the selected images are stored into the buffer memory prior to processing the selected images, and wherein the unselected images are not stored in the buffer memory.
